(19) United States
(12) Patent Application Publication
(10) Pub. No.: US 2026/0266530 A1
(43) Pub. Date: Sep. 10, 2026

(54) PLANT-PRESERVING REFRIGERATOR

(71) Applicant: MINEA ELECTRICAL APPLIANCE CO., LTD, Guangdong (CN)

(72) Inventor: Xiang Xing Li, Guangdong (CN)

(73) Assignee: MINEA ELECTRICAL APPLIANCE CO., LTD, Guangdong (CN)

(21) Appl. No.: 19/393,667

(22) Filed: Nov. 19, 2025

(30) Foreign Application Priority Data
Mar. 10, 2025 (CN) 202510282328.5
Mar. 10, 2025 (CN) 202510282336.X
Mar. 10, 2025 (CN) 202510283683.4

(51) Int. Cl. F25D 21/14; A01G 13/08; F25D 29/00; F25D 31/00

(52) U.S. Cl. CPC F25D 21/14; A01G 13/08; F25D 29/008; F25D 31/005; F25D 2317/04131; F25D 2400/02

(57) ABSTRACT

A plant-preserving refrigerator includes: an outer case; an inner case provided inside the outer case and having a plant-preserving space inside where a plant is preserved; an evaporator generating cold air to supply the air to the plant-preserving space of the inner case; a storage water tank storing replenishment water to control a humidity of the plant-preserving space of the inner case by being supplied to the plant-preserving space of the inner case; a recovery water tank connected to the inner case to recover defrosted water generated in the plant-preserving space of the inner case; and a water collection hopper connected to the recovery water tank and guiding the defrosted water generated in the plant-preserving space of the inner case to be recovered to the recovery water tank.

### CROSS-REFERENCE TO RELATED PATENT APPLICATION

This application claims the benefit of Chinese Patent Application No. 202510283683.4, 202510282336.X and 202510282328.5, all of which were filed on Mar. 10, 2025, in the China National Intellectual Property Administration (CNIPA), the disclosure of which is incorporated herein in its entirety by reference.

### BACKGROUND

The present disclosure relates to a plant-preserving refrigerator.

In general, plants contain a lot of moisture, and the freshness of plants may be retained by the moisture contained in the plants. Additionally, the freshness of plants may be a decisive factor in assessing the value of the plant. Therefore, research and development are increasing on devices capable of securing excellent marketability of plants by maintaining the freshness of plants for a long time.

As a part of this research and development, there is growing interest in a plant-preserving refrigerator that are able to keep plants fresh by having a plant-preserving space formed inside and controlling the temperature and humidity of the plant-preserving space to those suitable for plant-preserving.

Meanwhile, a conventional plant-preserving refrigerator is equipped with a cooling cycle inside to control the temperature of the plant-preserving space to a temperature suitable for preserving plants, and by spraying replenishment water stored in a separate water tank into the plant-preserving space, the humidity of the plant-preserving space is controlled to a humidity suitable for preserving plants.

However, since the conventional plant-preserving refrigerator does not have a separate water tank to recover defrosted water generated by the cooling cycle, the defrosted water generated by the cooling cycle is recovered to a water tank that stores the replenishment water for controlling the humidity of the plant-preserving space.

As such, since the conventional plant-preserving refrigerator has a structure in which the replenishment water and the defrosted water circulate within a single water tank, there is a problem in that it is difficult to gradually dry plants over a long period of time while maintaining the temperature and humidity of the plant-preserving space constant.

Accordingly, there is a need for development of a plant-preserving refrigerator which is capable of slowly drying plants over a long period of time while maintaining the temperature and humidity of the plant-preserving space constant by improving the conventional structure in which the replenishment water and the defrosted water circulate within a single water tank.

### SUMMARY

Embodiments of the present disclosure have been devised to address the aforementioned conventional problems and are directed to providing a plant-preserving refrigerator capable of gradually drying plants for a long period of time while maintaining a temperature and humidity of a plant-preserving space constant by improving a conventional structure in which replenishment water and defrosted water circulate within a single water tank.

According to one aspect of the present disclosure, it is possible to provide a plant-preserving refrigerator includes: an outer case; an inner case provided inside the outer case and having a plant-preserving space in which a plant is preserved; an evaporator configured to generate cold air to be supplied to the plant-preserving space of the inner case; a storage water tank configured to store replenishment water to be supplied to the plant-preserving space of the inner case and to enable a humidity of the plant-preserving space of the inner case to be controlled; a recovery water tank configured to communicate with the inner case to recover defrosted water generated in the plant-preserving space of the inner case; and a water collection hopper connected to the recovery water tank and guiding the defrosted water generated in the plant-preserving space of the inner case to be recovered into the recovery water tank.

According to embodiments of the present disclosure, there is an effect that it is possible to gradually dry plants for a long period of time while maintaining a temperature and humidity of a plant-preserving space constant by improving the conventional structure in which replenishment water and defrosted water circulate within a single water tank.

### BRIEF DESCRIPTION OF THE DRAWINGS

FIG. 1 is a perspective view illustrating a plant-preserving refrigerator according to one embodiment of the present disclosure.

FIG. 2 is a front view of the plant-preserving refrigerator in FIG. 1.

FIG. 3 is a plan view of the plant-preserving refrigerator in FIG. 1.

FIG. 4 is a cross-sectional view taken along line A-A in FIG. 2.

FIG. 5 is a control block diagram for an alarm of the plant-preserving refrigerator in FIG. 1.

FIG. 6 is a cross-sectional view taken along line B-B in FIG. 2.

FIG. 7 is a cross-sectional view taken along line C-C in FIG. 3.

FIG. 8 is a control block diagram for the temperature-humidity control of the plant-preserving refrigerator in FIG. 1.

FIG. 9 is a cross-sectional view taken along line D-D in FIG. 2.

FIG. 10 is a cross-sectional view taken along line E-E in FIG. 2.

FIG. 11 is a cross-sectional view taken along line F-F in FIG. 3.

FIG. 12 is a cross-sectional view taken along line G-G in FIG. 3.

FIG. 13 is a cross-sectional view taken along line H-H in FIG. 2.

### DETAILED DESCRIPTION OF THE EMBODIMENTS

Hereinafter, specific embodiments for implementing the spirit of the present disclosure will be described in detail with reference to the drawings.

In addition, in descriptions of the present disclosure, when it is determined that detailed descriptions of related well-known configurations and functions might obscure the gist of the present disclosure, detailed descriptions thereof will be omitted.

In addition, it will be understood that when a component is referred to as being “connected” to another component, it can be directly connected to the other component or intervening components may be present.

The terminology used herein is for the purpose of describing particular embodiments only and is not intended to be limiting of the present disclosure. Singular expressions include plural expressions unless the context clearly indicates otherwise.

In addition, expressions such as “one side”, “the other side”, “upper side”, “lower side”, “front side”, “rear side”, "upper side", “rear side”, etc. in this specification are explained based on the drawings and may be expressed differently when the direction of the object changes. For the same reason, some components in the attached drawings are exaggerated, omitted, or schematically depicted, and the size of each component does not entirely reflect the actual size.

In addition, terms that include ordinal numbers, such as "first," "second," etc., may be used to describe various components, but these components are not limited by such terms. These terms are only used to distinguish one component from another.

The term "comprising" as used in the specification means specifying a particular characteristic, region, integer, step, operation, element and/or component, but does not exclude the presence or addition of other particular characteristics, regions, integers, steps, operations, elements, components and/or groups.

Hereinafter, a plant-preserving refrigerator according to one embodiment of the present disclosure will be described with reference to the drawings.

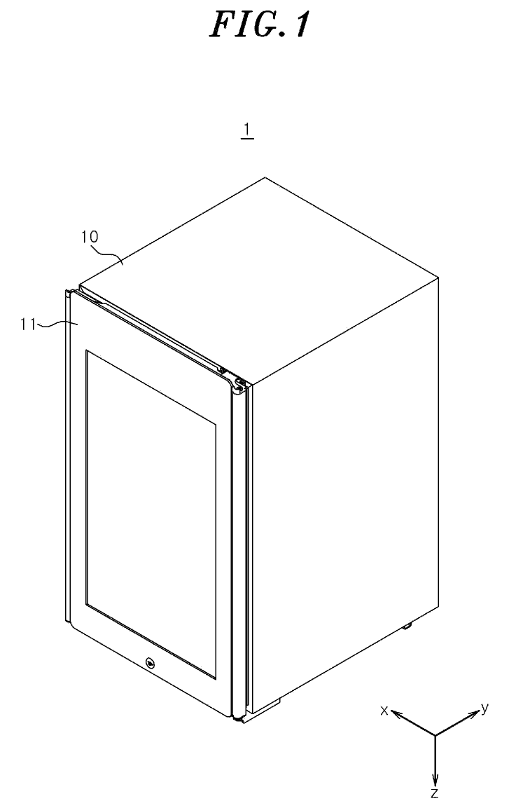

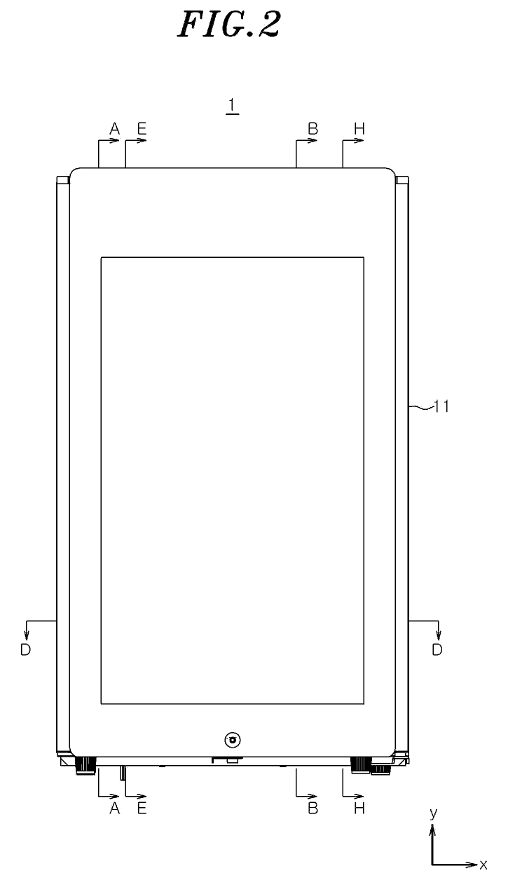

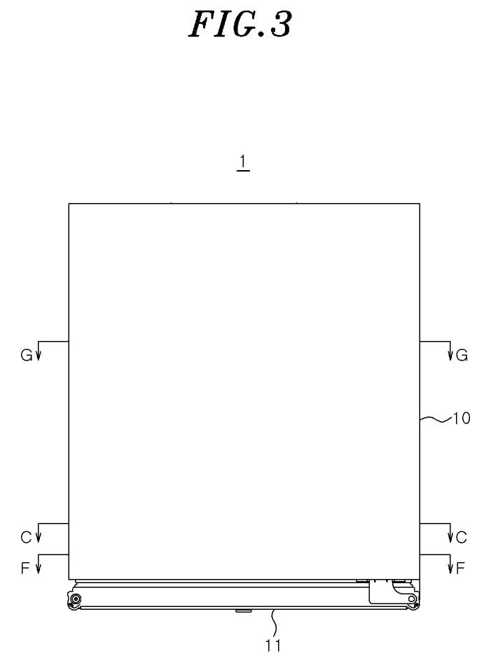

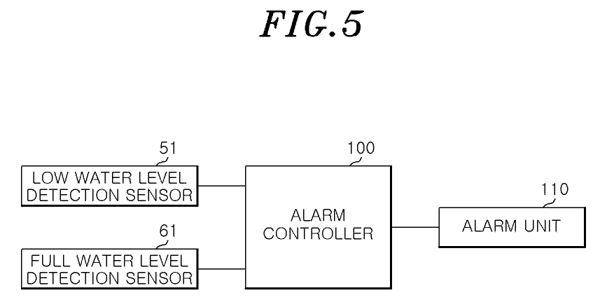

Referring to FIGS. 1 to 5, a plant-preserving refrigerator 1 according to one embodiment of the present disclosure may include an outer case 10, an inner case 20, a shelf 30, an evaporator 40, a storage water tank 50, a recovery water tank 60, a collection water tank 70, a water collection hopper 80, a lower body 90, an alarm controller 100, and an alarm unit 110.

The outer case 10 may form an outer appearance of the plant-preserving refrigerator 1.

The inner case 20 may have a plant-preserving space 21 capable of preserving plants inside thereof.

To this end, the inner case 20 may be provided inside the outer case 10 but positioned within the outer case 10 to be spaced apart from the outer case 10. An insulating material (not shown) may be filled between the outer case 10 and the inner case 20.

The front of the inner case 20 may be opened, and the plant-preserving space 21 formed inside the inner case 20 may be opened or closed by a door 11 which is connected to the open front of the inner case 20.

In the present embodiment, a degree of dryness of the plant, which is an important factor in maintaining the freshness of the plant in the plant-preserving space 21, may be objectively identified in real time, and a temperature and humidity of the plant-preserving space 21 may be controlled based on the objectively identified degree of dryness of the plant. This will be described later.

A machine room 22 may be provided below the inner case 20. The machine room 22 may be formed inside the outer case 10. Additionally, the machine room 22 may be provided below the plant-preserving space 21 inside the outer case 10 but may form an independent space from the plant-preserving space 21.

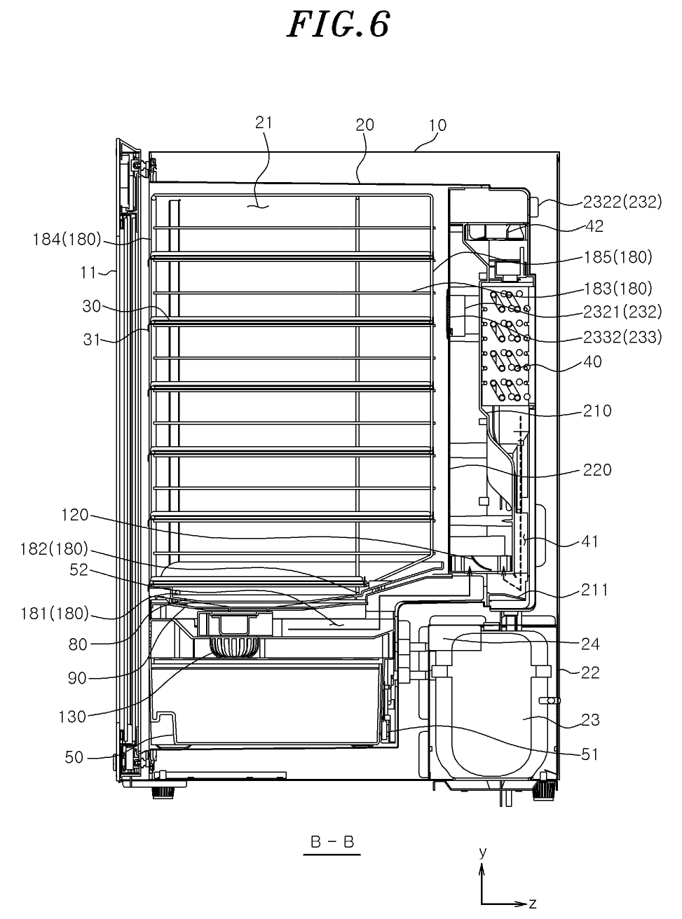

The machine room 22 may be provided with a compressor 23 and a condenser 24 (see FIG. 6). In addition, a collection water tank 70 may be disposed in the machine room 22 to collect defrosted water discharged by overflow from the recovery water tank 60. The collection water tank 70 may be disposed adjacent to the compressor 23 inside the machine room 22. Accordingly, the defrosted water collected by the collection water tank 70 may be evaporated by heat generated from the compressor 23.

As will be described later, the recovery water tank 60 is a water tank that recovers the defrosted water generated in the plant-preserving space 21 of the inner case 20, and the recovery water tank 60 into which the defrosted water is recovered may be manually emptied by a user at a predetermined time or may be automatically drained to the collection water tank 70. This will be described later.

The shelf 30 is a portion on which a plant requiring preservation is selectively placed and may be provided inside the inner case 20.

The shelf 30 may be provided in the plant-preserving space 21 of the inner case 20 and supported by a shelf tray 31. The shelf tray 31 may be connected to a rear connection frame 185 of a load transfer unit 180 which will be described later, thereby fixing a position of the shelf tray 31 with respect to the plant-preserving space 21. This will be described later.

A plurality of shelves 30 may be provided, and the plurality of shelves 30 may be disposed spaced apart from each other in a vertical direction of the inner case 20. A plurality of shelf trays 31 that are spaced apart in the vertical direction of the inner case 20 may be mutually fixed by the rear connection frame 185 of the load transfer unit 180, which will be described later. Here, when the terms for the direction is defined, the vertical direction of the inner case 20 refers to a y-axis direction in FIG. 1.

Meanwhile, in a state in which the plurality of shelves 30 are mutually fixed by the rear connection frame 185 of the load transfer unit 180 to be described later, the shelf 30, which is positioned at the lowest position among the plurality of shelves 30, is supported by the water collection hopper 80, and thus a load applied to the plurality of shelves 30 may be applied to the water collection hopper 80. Furthermore, the load applied to the plurality of shelves 30 may be measured by a load measurement member 190 in the water collection hopper 80. This will be described later.

The evaporator 40 may generate cold air to be supplied to the plant-preserving space 21 of the inner case 20.

To this end, the evaporator 40 may be provided at a rear side of the inner case 20. The cold air generated in the evaporator 40 may be supplied to the plant-preserving space 21 of the inner case 20 by a cold air fan 41 (see FIG. 6) provided above the evaporator 40.

Meanwhile, in a case of the present embodiment, when it is determined that a temperature and humidity of the cold air to be supplied to the plant-preserving space 21 of the inner case 20 need to be changed, the cold air generated in the evaporator 40 may be supplied to the plant-preserving space 21 by the mixing fan 120 provided below the evaporator 40.

As such, the cold air supplied to the plant-preserving space 21 of the inner case 20 by the mixing fan 120 may be mixed with at least one of the humid air passed through the storage water tank 50 and outside air heated by the heater 150 to be supplied to the plant-preserving space 21 of the inner case 20. Whether the temperature and humidity of the cold air to be supplied to the plant-preserving space 21 of the inner case 20 needs to be changed may be determined by a temperature-humidity controller 160, which will be described later.

The storage water tank 50 may store replenishment water that is supplied to the plant-preserving space 21 of the inner case 20 to control a humidity of the plant-preserving space 21 of the inner case 20.

To this end, the storage water tank 50 may be disposed below the inner case 20. The storage water tank 50 may be disposed below the inner case 20 and provided in front of the machine room 22.

The storage water tank 50 may be provided with a low water level detection sensor 51 for detecting a low water level of the replenishment water stored in the storage water tank 50. A value detected in the low water level detection sensor 51 is transmitted to the alarm controller 100 to be used to determine whether to trigger an alarm.

When the value detected by the low water level detection sensor 51 corresponds to a low water level state of the storage water tank 50, a low water level alarm may be triggered by the alarm unit 110. When a user recognizes the low water level alarm for the storage water tank 50 triggered by the alarm unit 110, the replenishment water may be replenished in the storage water tank 50 by the user.

The recovery water tank 60, which is a portion that recovers the defrosted water generated in the plant-preserving space 21 of the inner case 20, may be disposed below the inner case 20 and provided at one side of the storage water tank 50 and in front of the machine room 22.

The recovery water tank 60 may be provided with a full water level detection sensor 61 to detect a full water level of the defrosted water recovered by the recovery water tank 60. A value detected in the full water level detection sensor 61 is transmitted to the alarm controller 100 to be used to determine whether to trigger an alarm. When the value detected in the full water level detection sensor 61 corresponds to the full water level state of the recovery water tank 60, a full water level alarm may be triggered by the alarm unit 110.

When the user recognizes the full water level alarm for the recovery water tank 60 triggered by the alarm unit 110, the defrosted water in the recovery water tank 60 may be manually discarded by the user. In addition, even when the recovery water tank 60 is not emptied despite the full water level alarm by the alarm unit 110, the defrosted water in the recovery water tank 60 may be automatically discharged to the collection water tank 70.

The collection water tank 70 may collect the defrosted water discharged by overflow from the recovery water tank 60.

To this end, the collection water tank 70 may be connected to the recovery water tank 60 and disposed inside the machine room 22. The collection water tank 70 may be disposed adjacent to the compressor 23 inside the machine room 22.

The defrosted water collected in the collection water tank 70 may be evaporated by heat generated in the machine room 22. Here, the heat generated in the machine room 22 may be compression heat generated in the compressor 23 disposed in the machine room 22.

The water collection hopper 80 may guide the defrosted water generated in the plant-preserving space 21 of the inner case 20 to be recovered into the recovery water tank 60.

To this end, the water collection hopper 80 may be provided above the storage water tank 50 and the recovery water tank 60 and connected to the recovery water tank 60.

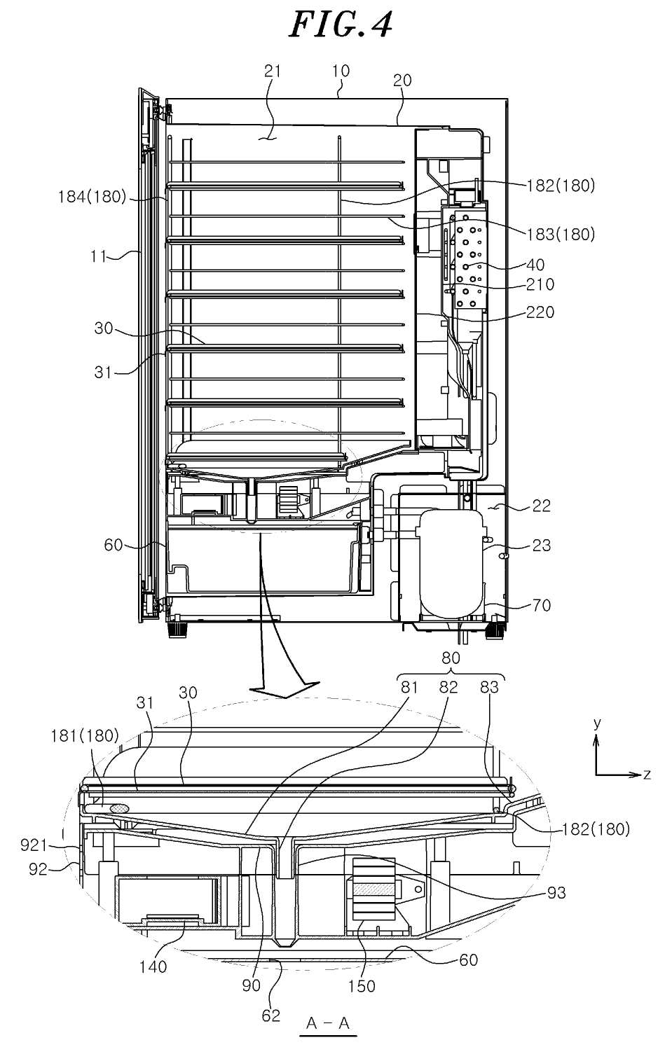

As shown in FIG. 4, the water collection hopper 80 may include a water collection unit 81 collecting the defrosted water generated in the plant-preserving space 21 of the inner case 20, a connection unit 82 connected to the water collection unit 81, coupled in communication with the lower body 90, and providing a movement path for the defrosted water collected in the water collection unit 81, and a guide unit 83 connected to at least a part of the circumference of the water collection unit 81 and guiding the defrosted water generated in the plant-preserving space 21 of the inner case 20 to the water collection unit 81.

The water collection unit 81 may collect at least one of defrosted water generated in the plant-preserving space 21 of the inner case 20, for example, defrosted water generated by the evaporator 40, replenishment water sprayed into the plant-preserving space 21 of the inner case 20 and then condensed in the plant-preserving space 21 of the inner case 20, and water generated in a plant placed on the shelf 30.

Defrosted water collected in the water collection unit 81 may be provided to the connection unit 82. An upper surface of the water collection unit 81 may be formed as at least one inclined surface in order for the defrosted water collected in the water collection unit 81 to be smoothly supplied to the connection unit 82. The inclined surface formed in the water collection unit 81 may be a downwardly inclined surface in a direction from an upper side toward a lower side of the inner case 20.

The connection unit 82 may be fitted into a coupling unit 93 of the lower body 90, which will be described later. An end of the coupling unit 93 of the lower body 90, which will be described later, may be disposed above an inlet 62 of the recovery water tank 60. Accordingly, the defrosted water collected in the water collection unit 81 may flow through the connection unit 82 toward the end of the coupling unit 93 of the lower body 90, which will be described later, and may be discharged from the end of the coupling unit 93 of the lower body 90, which will be described later, to be introduced into the inlet 62 of the recovery water tank 60.

The guide unit 83 may be disposed adjacent to the rear side of the inner case 20 relative to the water collection unit 81. The upper surface of the guide unit 83 may be formed as an inclined surface so that the defrosted water generated in the plant-preserving space 21 of the inner case 20 may be smoothly supplied to the water collection unit 81. The inclined surface formed in the guide unit 83 may be a downwardly inclined surface in a direction from the upper side toward the lower side of the inner case 20.

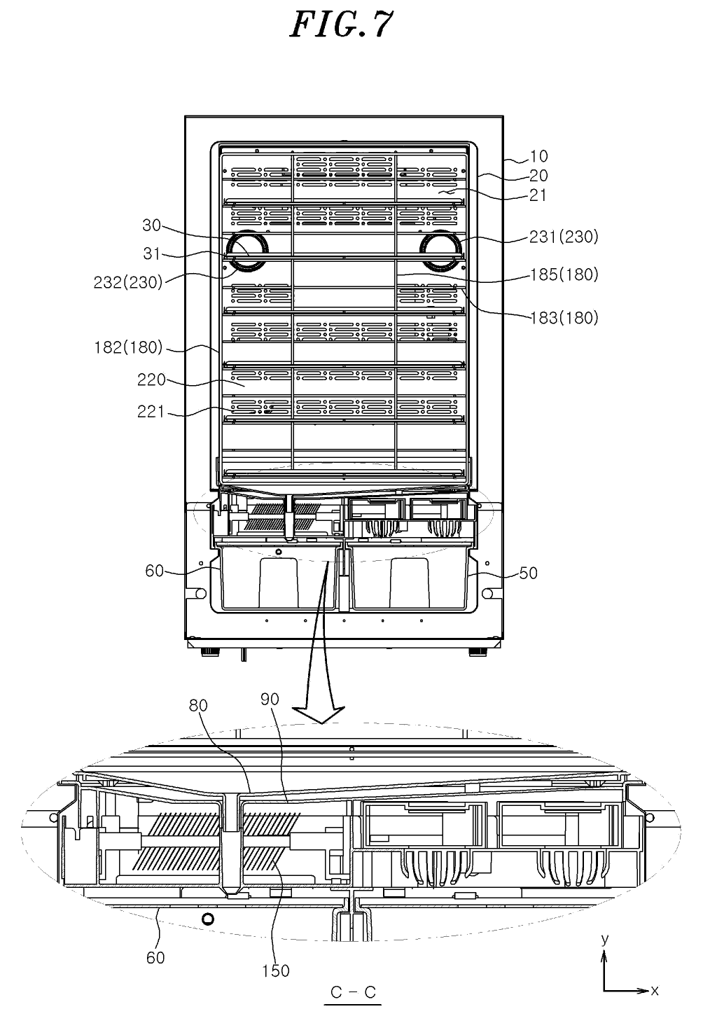

The lower body 90 may guide defrosted water collected into the water collection hopper 80 to the recovery water tank 60. Additionally, the lower body 90 may support a load measurement member 190 connected to a lower surface of the water collection hopper 80. In addition, the lower body 90 may provide a space in which devices for controlling the temperature and humidity of the plant-preserving space 21 of the inner case 20, for example, a storage water tank-side blowing fan 130 (see FIG. 6), a recovery water tank-side blowing fan 140 (see FIG. 7), and the heater 150 (see FIG. 7), are installed.

To this end, the lower body 90 may be disposed between the water collection hopper 80 and the recovery water tank 60. The lower body 90 may be provided with a support seating groove 91 in which the load measurement member 190 connected to the lower surface of the water collection hopper 80 is seated and supported.

Meanwhile, a front surface 92 of the lower body 90 may be provided with an outside air intake port 921 through which outside air may be introduced. The outside air introduced through the outside air intake port 921 may flow toward the heater 150 through the recovery water tank-side blowing fan 140 connected to an upper side of the lower body 90, and, after being heated by the heater 150, may flow toward the mixing fan 120. This will be described later.

The alarm controller 100 may generate an alarm signal based on a value detected by the low water level detection sensor 51 of the storage water tank 50 and a value detected by the full water level detection sensor 61 of the recovery water tank 60.

For example, when the value detected by the low water level detection sensor 51 of the storage water tank 50 corresponds to a low water level state of the storage water tank 50, the alarm controller 100 may generate a low water level alarm signal for the storage water tank 50 to transmit the signal to the alarm unit 110.

In addition, for example, when the value detected in the full water level detection sensor 61 of the recovery water tank 60 corresponds to a full water level state for the recovery water tank 60, the alarm controller 100 may generate a full water level alarm signal for the recovery water tank 60 to transmit the signal to the alarm unit 110.

The alarm unit 110 may receive the low water level alarm signal for the storage water tank 50 from the alarm controller 100 to trigger the low water level alarm for the storage water tank 50 or receive the full water level alarm signal for the recovery water tank 60 to trigger the full water level alarm for the recovery water tank 60.

The alarm unit 110 may be provided as an alarm device, e.g., a display device, that allow a user to visually recognize the low water level alarm for the storage water tank 50 and the full water level alarm for the recovery water tank 60, or may be provided warning devices, e.g., an alarm device, that allow a user to audibly recognize the low water level alarm for the storage water tank 50 and the full water level alarm for the recovery water tank 60.

When the low water level alarm for storage water tank 50 is triggered through the alarm unit 110, the user may replenish the replenishment water into the storage water tank 50, and when the full water level alarm for the recovery water tank 60 is triggered through the alarm unit 110, the defrosted water in the recovery water tank 60 in the full water level state may be manually discarded by the user who has recognized the full water level alarm signal or may be automatically drained to the collection water tank 70.

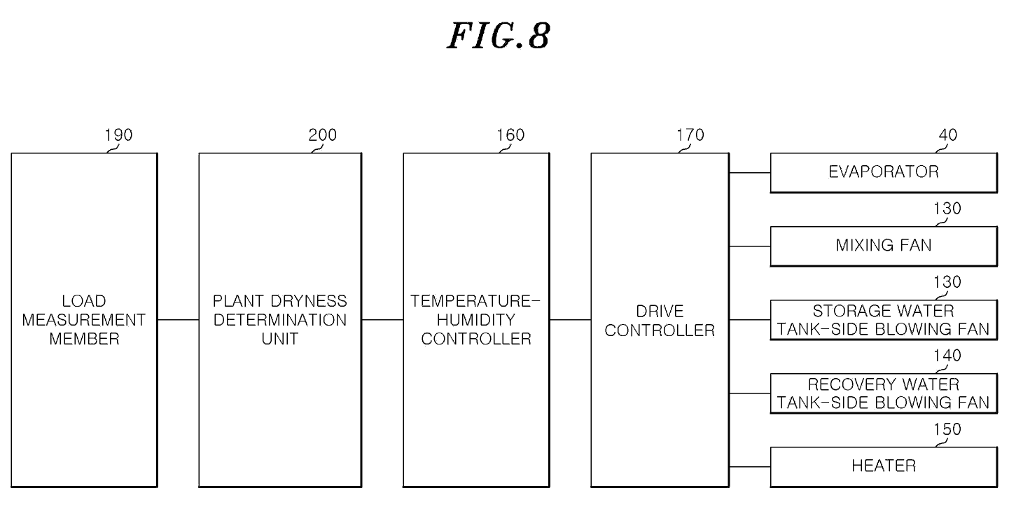

Referring further to FIGS. 6 to 8, the plant-preserving refrigerator 1 according to one embodiment of the present disclosure may further include a mixing fan 120, a storage water tank-side blowing fan 130, a temperature-humidity controller 160, and a drive controller 170.

As shown in FIG. 6, the mixing fan 120 may mix humid air supplied in one direction after passing through the storage water tank 50 with cold air generated by the evaporator 40 and supplied in another direction different from the one direction to provide the mixed air to the plant-preserving space 21 of the inner case 20. In this embodiment, the one direction refers to a direction from the front side toward the rear side of the inner case 20, for example, a +z-axis direction in FIG. 6, and the other direction refers to a direction from the upper side to the lower side of the inner case 20, for example, a -y-axis direction in FIG. 6.

The humid air passing through the storage water tank 50 may flow in one direction along an air flow path 52 formed between the water collection hopper 80 and the lower body 90, as indicated by the solid arrow in FIG. 6. Additionally, the cold air generated by the evaporator 40 may flow in the other direction along the cold air flow path 41 formed between the inner case 20 and the installation housing 210 as indicated by the dotted arrow in FIG. 6. In other words, the cold air generated by the evaporator 40 and the humid air passing through the storage water tank 50 may be mixed vertically.

To this end, the mixing fan 120 may be disposed between the front side of the evaporator 40 and the rear side of the storage water tank 50. The mixing fan 120 may be disposed below the evaporator 40 and disposed above the storage water tank 50. Additionally, the mixing fan 120 may be provided inside the inner case 20, disposed at the rear side of the shelf 30, and provided in the installation housing 210 with its front side open.

The storage water tank-side blowing fan 130 may allow the humid air that has passed through the storage water tank 50 to flow into the air flow path 52 formed between the water collection hopper 80 and the lower body 90 so as to be supplied to the mixing fan 120.

To this end, the storage water tank-side blowing fan 130 may be disposed above the storage water tank 50. The storage water tank-side blowing fan 130 may be disposed adjacent to the front side of the inner case 20 relative to the mixing fan 120.

The storage water tank-side blowing fan 130 may be provided in the lower body 90 connected to the storage water tank 50. The storage water tank-side blowing fan 130 may allow the humid air that has passed through the storage water tank 50 to flow along the air flow path 52 formed between the water collection hopper 80 and the lower body 90 in a direction from the front side toward the rear side of the inner case 20. Since the mixing fan 120 is provided at the rear side of the storage water tank-side blowing fan 130, the humid air that gas passed through the storage water tank 50 may be supplied to the plant-preserving space 21 of the inner case 20 through the mixing fan 120.

In this case, as the cold air generated by the evaporator 40 is also supplied to the mixing fan 120, the mixing fan 120 may mix the humid air supplied through the storage water tank-side blowing fan 130 with the cold air generated by the evaporator 40 and may supply the air to the plant-preserving space 21 of the inner case 20.

The temperature-humidity controller 160 may generate a temperature-humidity control signal of the plant-preserving space 21 of the inner case 20 based on a degree of dryness of the plant placed on the shelf 30. The degree of dryness of the plant placed on the shelf 30 may be objectively identified in real time by a plant dryness determination unit 200.

The temperature-humidity controller 160 may generate a temperature-reduction signal for lowering the temperature of the plant-preserving space 21 of the inner case 20 based on the degree of dryness of the plant. The temperature-reduction signal generated by the temperature-humidity controller 160 may be transmitted to the drive controller 170.

The drive controller 170 may receive the temperature-reduction signal generated by the temperature-humidity controller 160. When the drive controller 170 receives the temperature-reduction signal generated by the temperature-humidity controller 160, the drive controller 170 may control driving of at least one of the evaporator 40, the mixing fan 120, and the storage water tank-side blowing fan 130 based on the temperature-reduction signal.

As an example, the drive controller 170 upon receiving the temperature-reduction signal generated by the temperature-humidity controller 160 may control a pump rotation speed of the evaporator 40 by means of an inverter based on the temperature-reduction signal and may control the air flow rates of the mixing fan 120 and the storage water tank-side blowing fan 130, thereby controlling a temperature and humidity of the air supplied to the plant-preserving space 21 of the inner case 20.

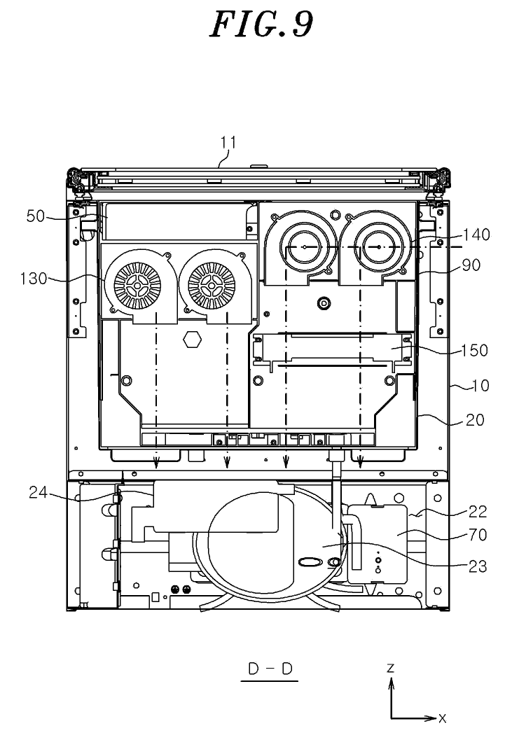

Referring further to FIG. 9, the plant-preserving refrigerator 1 according to one embodiment of the present disclosure may further include a recovery water tank-side blowing fan 140 and a heater 150.

The recovery water tank-side blowing fan 140 may allow outside air introduced above the recovery water tank 60 to flow toward the heater 150 so that the outside air introduced above the recovery water tank 60 may be heated by the heater 150. Additionally, the recovery water tank-side blowing fan 140 may allow the outside air heated by the heater 150 to flow into the air flow path 52 formed between the water collection hopper 80 and the lower body 90 so as to be supplied to the mixing fan 120.

To this end, the recovery water tank-side blowing fan 140 may be disposed above the recovery water tank 60. The recovery water tank-side blowing fan 140 may be provided adjacent to the front side of the inner case 20 relative to the mixing fan 120.

The recovery water tank-side blowing fan 140 may be provided in the lower body 90 connected onto the recovery water tank 60. The outside air heated by the heater 150 may flow in a direction from the front side toward the rear side of the inner case 20 along the air flow path 52 formed between the water collection hopper 80 and the lower body 90. Since the mixing fan 120 is provided at the rear side of the recovery water tank-side blowing fan 140, the outside air heated by the heater 150 may be supplied to the plant-preserving space 21 of the inner case 20 through the mixing fan 120.

In this case, the humid air supplied through the storage water tank-side blowing fan 130 is also supplied to the mixing fan 120, as shown in FIG. 9, the mixing fan 120 may mix the humid air supplied in one direction after passing through the storage water tank 50 with the outside air heated by the heater 150 and supplied in the same one direction so as to provide the air to the plant-preserving space 21 of the inner case 20. In the embodiment, the one direction refers to a direction from the front toward the rear side of the inner case 20, for example, a -z-axis direction in FIG. 9.

As indicated by the alternating-long-and-short dashed arrow in FIG. 9, the humid air that has passed through the storage water tank 50 may flow in the one direction along the air flow path 52 formed between the water collection hopper 80 and the lower body 90. Additionally, as indicated by the double-dashed arrows in FIG. 9 the outside air heated by the heater 150 may flow in the one direction along the air flow path 52 formed between the water collection hopper 80 and the lower body 90. In other words, the humid air having passing through the storage water tank 50 and the outside air heated by heater 150 may be mixed horizontally.

The temperature-humidity controller 160 may generate a temperature-humidity control signal for the plant-preserving space 21 of the inner case 20 based on the degree of dryness of the plant placed on the shelf 30. The degree of dryness of the plant placed on the shelf 30 may be objectively identified in real time by the plant dryness determination unit 200.

The temperature-humidity controller 160 may generate a temperature-increase signal for raising the temperature of the plant-preserving space 21 of the inner case 20 based on the degree of dryness of the plant. The temperature-increase signal generated by the temperature-humidity controller 160 may be transmitted to the drive controller 170.

The drive controller 170 may receive the temperature-increase signal generated by the temperature-humidity controller 160. When the drive controller 170 receives the temperature-increase signal generated by the temperature-humidity controller 160, the drive controller 170 may control the driving of at least one of the evaporator 40, the mixing fan 120, the storage water tank-side blowing fan 130, the recovery water tank-side blowing fan 140, and the heater 150 based on the temperature-increase signal.

As an example, the drive controller 170 upon receiving the temperature-increase signal generated by the temperature-humidity controller 160 may stop the driving of the evaporator 40 drive the heater 150, based on the temperature-increase signal, and control the air flow rates of the mixing fan 120, the storage water tank-side blowing fan 130, and the recovery water tank-side blowing fan 140, thereby controlling the temperature and humidity of the air supplied to the plant-preserving space 21 of the inner case 20.

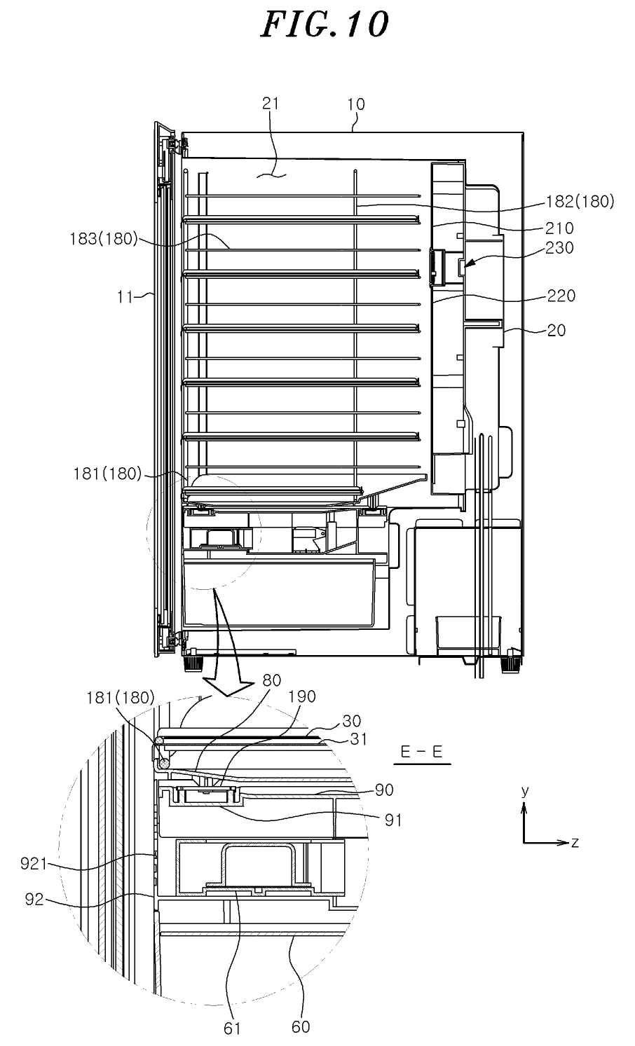

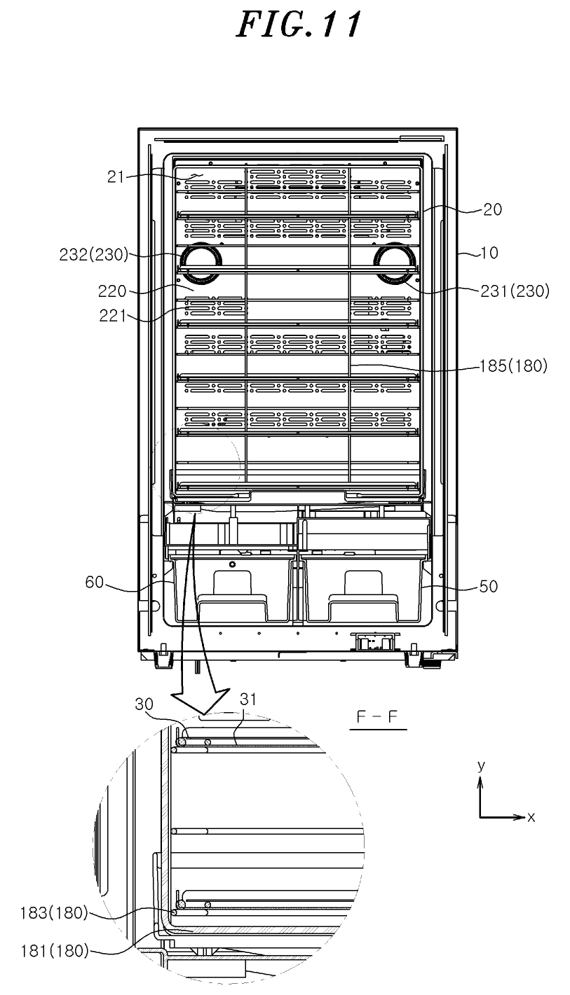

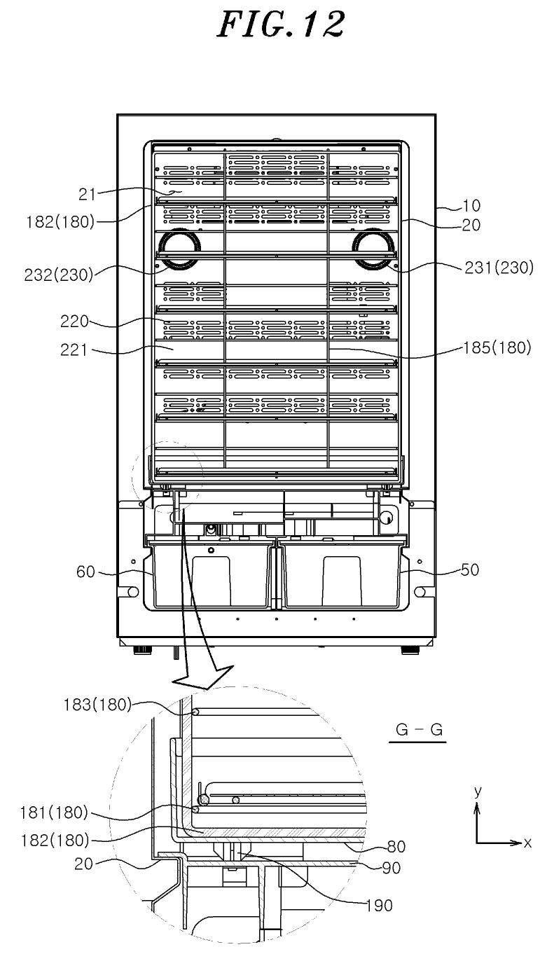

Referring further to FIGS. 10 to 12, the plant-preserving refrigerator 1 according to one embodiment of the present disclosure may further include a load transfer unit 180, a load measurement member 190, and a plant dryness determination unit 200.

The load transfer unit 180 may transfer a load of the shelf 30 to the water collection hopper 80.

To this end, the load transfer unit 180 may include a first contact frame 181, a second contact frame 182, a support frame 183, a front connection frame 184, and a rear connection frame 185.

The first contact frame 181 may be supported on one side of the water collection hopper 80, and the second contact frame 182 may be supported on the other side of the water collection hopper 80.

The support frame 183, which is a frame for supporting the shelf 30, may be connected to the first contact frame 181. The support frame 183 may restrict the second contact frame 182 from moving in a direction from one side or the other toward the other side or one side of the water collection hopper 80.

The front connection frame 184 may be connected to a front side of the first contact frame 181, and the rear connection frame 185 may be connected to a rear side of the first contact frame 181.

The rear connection frame 185 may be connected to the shelf tray 31 supporting the shelf 30 and may mutually fix the plurality of shelf trays 31 that are disposed spaced apart from each other in a vertical direction of the inner case 20.

The load measurement member 190 may measure the load of the shelf 30 transmitted through the load transfer unit 180.

To this end, the load measurement member 190 may be connected to the water collection hopper 80 and may be supported by the lower body 90 disposed below the water collection hopper 80. The load measurement member 190, which is disposed below the water collection hopper 80, may be placed in the support seating groove 91 formed in the lower body 90. For example, the load measurement member 190 may be provided as a load cell.

A change in the load of the shelf 30 on which the plant is placed may be detected through the load measurement member 190, and this load change value may be transmitted to the plant dryness determination unit 200 and utilized to determine a degree in which the moisture contained in the plant placed on the shelf 30 is dried based on the load change of the shelf 30.

The plant dryness determination unit 200 may determine the degree of dryness of plants placed on the shelf 30 by identifying the load change of the shelf 30 based on a measurement value of the load measurement member 190.

A determination result of the plant dryness determination unit 200 may be transmitted to the temperature-humidity controller 160. The temperature-humidity controller 160 upon receiving the determination result of the plant dryness determination unit 200 may generate the temperature-humidity control signal for the plant-preserving space 21 of the inner case 20.

The temperature-humidity control signal generated by the temperature-humidity controller 160 may be a temperature-increase signal for raising the temperature of the plant-preserving space 21 or a temperature-reduction signal for lowering the temperature of the plant-preserving space 21.

The temperature-increase signal or the temperature-reduction signal generated by the temperature-humidity controller 160 may be transmitted to the drive controller 170 and utilized to control driving of devices that control the temperature and humidity of the plant-preserving space 21. Since this has been described with reference to FIGS. 6 to 9, repeated descriptions will be omitted.

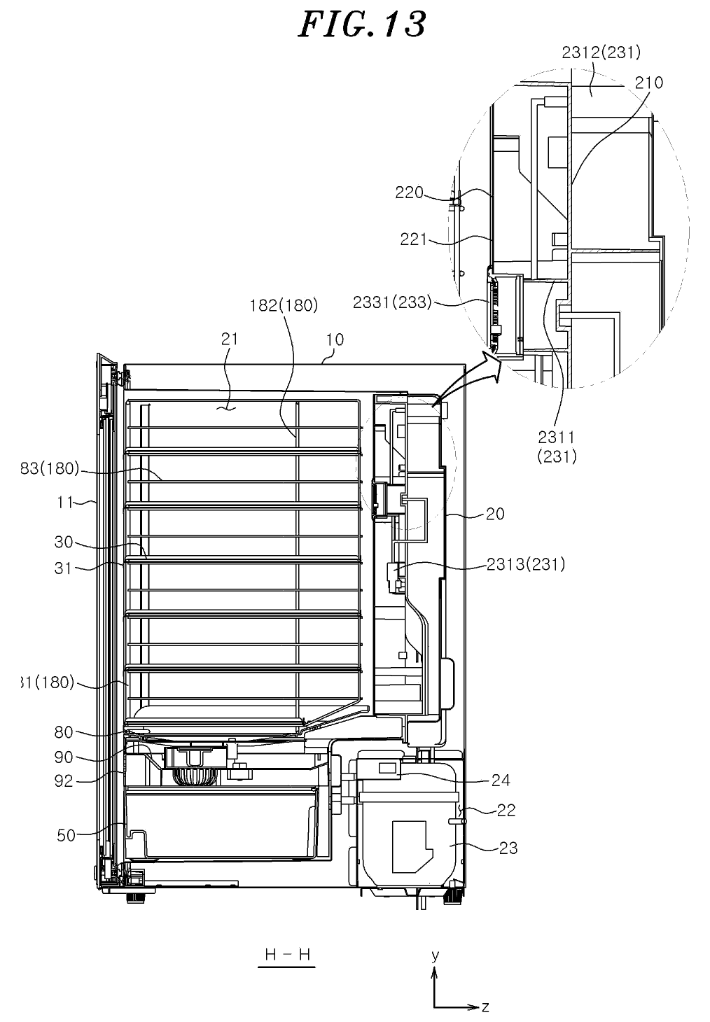

Referring further to FIG. 13, the plant-preserving refrigerator 1 according to one embodiment of the present disclosure may further include an installation housing 210, a cover plate 220, and a ventilation unit 230.

The installation housing 210 may be provided inside the inner case 20 and may be disposed at the rear side of the shelf 30. A front side of the installation housing 210 may be open, and the cover plate 220 may be connected to the open front side of the installation housing 210.

A cold air fan 42 may be installed at an upper side of the installation housing 210, and the mixing fan 120 may be installed on a lower side of the installation housing 210. The installation housing 210 may be provided with a cold air guide unit 211 (see FIG. 6), and the cold air guide unit 211 may be provided below the mixing fan 120.

The cold air guide unit 211 may serve to guide cold air flowing along the cold air flow path 41 formed between the inner case 20 and the installation housing 210 toward the mixing fan 120. To this end, the cold air guide unit 211 may be provided with an inclined surface upwardly in a direction from the lower side toward the upper side of the inner case 20.

A flow space may be formed inside the installation housing 210, where at least one of air passing through the cold air fan 42 provided above the evaporator 40 and air passing through the mixing fan 120 provided below the evaporator 40 flows.

The cover plate 220 may cover the open front side of the installation housing 210. The cover plate 220 may be provided with a slit 221 formed through so that at least one of air passing through the cold air fan 42 provided above the evaporator 40 and air passing through the mixing fan 120 provided below the evaporator 40 is supplied toward the shelf 30.

The ventilation unit 230 may ventilate the air of the plant-preserving space 21 of the inner case 20.

To this end, the ventilation unit 230 may include an intake unit 231 provided at one side of the installation housing 210, an exhaust unit 232 provided at the other side of the installation housing 210, and a filter unit 233 provided in the intake unit 231 and the exhaust unit 232.

The intake unit 231 may filter contaminants contained in the air introduced into the plant-preserving space 21 of the inner case 20, thereby maintaining cleanliness of the air of the plant-preserving space 21 clean.

To this end, the intake unit 231 may include a front intake port 2311 provided on a front surface of the installation housing 210, a rear intake port 2312 provided on a rear surface of the installation housing 210 and connected to the front intake port 2311, and a compressor 2313 connected to the front intake port 2311.

The exhaust unit 232 may remove an odor generated from the plant in the plant-preserving space 21 when the air of the plant-preserving space 21 of the inner case 20 is discharged to the outside.

To this end, the exhaust unit 232 may include a front exhaust port 2321 (see FIG. 6) provided on the front surface of the installation housing 210 and a rear exhaust port 2322 (see FIG. 6) provided on a rear surface of the installation housing 210 and connected to the front exhaust port 2321.

The filter unit 233 may include an intake -side filter 2331, which is provided at the front intake port 2311 and filters air supplied to the rear intake port 2312, and an exhaust -side filter 2332 (see FIG. 6), which is provided at the front exhaust port 2321 and filters air supplied to the front exhaust port 2321 before being discharged to the rear exhaust port 2322. As an example, the intake -side filter 2331 and the exhaust -side filter 2332 may be provided as activated carbon filters.

Although the embodiments of the present disclosure have been described as specific embodiments, these are merely examples, and the present disclosure is not limited thereto, but should be construed as having the broadest scope in accordance with the basic idea disclosed in this specification. Those skilled in the art may implement patterns of shapes not specified by combining/substituting the disclosed embodiments, but this also does not depart from the scope of the present disclosure. In addition, those skilled in the art may easily modify or alter the disclosed embodiments based on this specification, and it is clear that such modifications or alterations also fall within the scope of the present disclosure.

What is claimed is:

1. A plant-preserving refrigerator, comprising:
an outer case;
an inner case provided inside the outer case and having a plant-preserving space in which a plant is preserved;
an evaporator configured to generate cold air to be supplied to the plant-preserving space of the inner case;
a storage water tank configured to store replenishment water to be supplied to the plant-preserving space of the inner case and to enable a humidity of the plant-preserving space of the inner case to be controlled;
a recovery water tank configured to communicate with the inner case to recover defrosted water generated in the plant-preserving space of the inner case; and
a water collection hopper connected to the recovery water tank and guiding the defrosted water generated in the plant-preserving space of the inner case to be recovered into the recovery water tank.

2. The plant-preserving refrigerator of claim 1, further comprising a collection water tank connected to the recovery water tank and collecting the defrosted water discharged by overflow from the recovery water tank.

3. The plant-preserving refrigerator of claim 2, wherein the collection water tank is disposed inside a machine room formed inside the outer case, and
the defrosted water that overflow from the recovery water tank and is collected in the collection water tank is evaporated by heat generated in the machine room.

4. The plant-preserving refrigerator of claim 2, wherein the storage water tank is provided with a low water level detection sensor that detects a low water level of replenishment water stored in the storage water tank.

5. The plant-preserving refrigerator of claim 4, wherein the recovery water tank is provided with a full water level detection sensor that detects a full water level of the defrosted water recovered into the recovery water tank.

6. The plant-preserving refrigerator of claim 5, further comprising:
an alarm controller configured to generate an alarm signal based on at least one detection value of the low water level detection sensor and the full water level detection sensor; and
an alarm unit configured to receive the alarm signal generated from the alarm controller and to trigger an alarm based on the alarm signal.

7. The plant-preserving refrigerator of claim 6, wherein, the alarm controller generates a full water level alarm signal and transmit the signal to the alarm unit when a value detected by the full water level detection sensor corresponds to a full water level state of the recovery water tank, and
the defrosted water in the recovery water tank in the full water level state is manually discarded by a user who has recognized the full water level alarm signal or is automatically drained to the collection water tank.

8. The plant-preserving refrigerator of claim 1, further comprising a lower body disposed between the water collection hopper and the recovery water tank and guiding the defrosted water collected in the water collection hopper to the recovery water tank.

9. The plant-preserving refrigerator of claim 8, wherein the water collection hopper comprises:
a water collection unit in which the defrosted water generated in the plant-preserving space of the inner case is collected; and
a connection unit connected to the water collection unit, coupled in communication with the lower body, and providing a movement path for the defrosted water collected in the water collection unit.

10. The plant-preserving refrigerator of claim 9, wherein the water collection hopper further comprises
a guide unit connected to at least a part of the circumference of the water collection unit and guiding the defrosted water generated in the plant-preserving space of the inner case to the water collection unit.

11. The plant-preserving refrigerator of claim 1, further comprising a mixing fan that mixes humid air supplied in one direction after passing through the storage water tank with cold air generated by the evaporator and supplied in another direction different from the one direction to provide the mixed air to the plant-preserving space of the inner case.

12. The plant-preserving refrigerator of claim 11, further comprising a storage water tank-side blowing fan disposed above the storage water tank,
wherein the mixing fan is provided adjacent to a rear side of the inner case relative to the storage water tank-side blowing fan.

13. The plant-preserving refrigerator of claim 12, wherein the storage water tank-side blowing fan is provided in a lower body connected to an upper portion of the storage water tank and further includes the water collection hopper disposed above the lower body and spaced apart from the lower body.

14. The plant-preserving refrigerator of claim 13, wherein an air flow path through which humid air passing through the storage water tank flows is formed between the water collection hopper and the lower body, and
the humid air passing through the storage water tank flows in a direction from the front toward the rear side of the inner case along the air flow path.

15. The plant-preserving refrigerator of claim 13, further comprising a shelf provided in the plant-preserving space of the inner case and on which a plant requiring preservation is selectively placed,
wherein the mixing fan is provided inside the inner case, disposed at the rear side of the shelf, and provided in the installation housing with its front side open, and
the storage water tank is provided below the inner case and disposed below the installation housing.

16. The plant-preserving refrigerator of claim 15, wherein the evaporator is disposed at the rear side of the inner case and disposed to be surrounded by the installation housing,
a cold air flow path through which cold air generated by the evaporator flows is formed between the inner case and the installation housing, and
the cold air flowing along the cold air flow path flows in a direction from an upper side toward a lower side of the inner case.

17. The plant-preserving refrigerator of claim 15, further comprising:
a plant dryness determination unit configured to determine a degree of dryness of a plant placed on the shelf by identifying a change in a load of the shelf on which the plant is placed;
a temperature-humidity controller configured to generate a temperature-humidity control signal for the plant-preserving space of the inner case based on a determination result of the plant dryness determination unit; and
a drive controller configured to receive the temperature-humidity control signal from the temperature-humidity controller and to control driving of at least one of the evaporator, the mixing fan, and the storage water tank-side blowing fan based on the temperature-humidity control signal.

18. The plant-preserving refrigerator of claim 1, further comprising:
a heater configured to heat outside air introduced into the inner case; and
a mixing fan configured to mix humid air supplied in one direction after passing through the storage water tank with the outside air heated by the heater and supplied in the same direction as the one direction and to provide the mixed air to the plant-preserving space of the inner case.

19. The plant-preserving refrigerator of claim 18, further comprising:
an evaporator disposed at the rear side of the inner case and selectively generating cold air to be supplied to the plant-preserving space of the inner case;
a recovery water tank provided at one side of the storage water tank and collecting defrosted water generated in the plant-preserving space of the inner case;
a storage water tank-side blowing fan disposed above the storage water tank; and
a recovery water tank-side blowing fan disposed above the recovery water tank,
wherein the mixing fan is disposed below the evaporator and provided adjacent to the rear side of the inner case relative to the storage water tank-side blowing fan and the recovery water tank-side blowing fan.

20. The plant-preserving refrigerator of claim 19, wherein the storage water tank-side blowing fan is provided in a lower body connected to the storage water tank and the recovery water tank, and
the heater is provided in the lower body.
